(19) United States
(12) Patent Application Publication
(10) Pub. No.: US 2002/0083594 A1
(43) Pub. Date: Jul. 4, 2002

(54) Scissors for cutting hair uniformly without pinching or tearing

(76) Inventor: Detlef Mattinger, Bickenbach (DE)

Correspondence Address: Striker Striker & Stenby, 103 East Neck Road, Huntington, NY, 11743, US

(21) Appl. No.: 09/947,958

(22) Filed: Sep. 6, 2001

Related U.S. Application Data
(62) Division of application No. 09/242,979, filed on Feb. 26, 1999, now Pat. No. 6,357,121.

(30) Foreign Application Priority Data
Aug. 9, 1997 (DE) 197 34 605.7

(51) Int. Cl. B26B 13/00

(52) U.S. Cl. 30/216; 30/228; 30/239

(57) ABSTRACT

To improve the cutting properties of a pair of scissors 1, such as hairdressing shears 11, it is proposed that at least one shank 4 be made to vibrate parallel to the longitudinal direction (6) of the blade (7) of this shank (4) by means of an electrically powered vibrator (5). The vibrator (5) may include a piezoelectric travel transducer (8), which deflects the blade (7) with an ultrasonic frequency.

The invention relates to a pair of scissors with two shanks joined to one another via a pivot joint, in particular hairdressing shears.

Known scissors operate by the principle of two cutting edges that move about a common, fixed pivot point relative to one another. In the process, the cutting edges slide on one another in such a way that the touch at point (the cutting point).

When the scissors close, the cutting point moves out of the direction of the common pivot point of the scissors in the direction toward the top of the scissors.

In this process, the opening angle of the scissors, that is, the angle of the cutting edges converging on one another, also changes.

Filament-like material to be cut, such as hair, depending on the opening angle, edge sharpness, and so forth, slides more or less far in front of the actual cutting point until it begins to be cut, is held, and then severed. Since in this cutting method, the material to be cut does not execute a defined rolling motion about its longitudinal axis, necessarily only a partial cross section of the material to be cut is actually cut, while the rest is virtually pinched off or torn off.

Poorly cut hair is finally the starting point for subsequent damage and can cause splitting, among other effects.

The object of the invention is to cut filamentary material to be cut, especially hair, uniformly over its circumference and cross section without any zones of pinching and tearing.

This object is attained in accordance with the characteristics of the body of claim 1. Accordingly, at least one shank can be made to vibrate parallel to the longitudinal direction of this shank by means of an electrically powered vibrator.

The invention has the advantage that filamentary material to be cut, in particular hair, can be cut uniformly over its circumference and cross section without pinching and tearing zones. With the scissors of the invention, the hair slides between the cutting edges while it is being cut through. In the process it is reliably and uniformly severed. When the scissors are closed, the axially oscillating motion component that is additionally superimposed on at least one cutting edge leads to improved cutting properties.

Further advantageous features of the invention are described in claims 2-10.

Good cutting results are attained if according to claim 2 the vibrator includes a piezoelectric travel transducer, which is located between the blade and an end of the shank toward the handle, and which is a connection between the blade and the end of the shank. The oscillating motion is determined by the frequency and amplitude at which the piezoelectric travel transducer vibrates.

The oscillating motion should be executed at such a high frequency that during normal use of scissors, the hair rolls over its circumference on the cutting edges at least once during the cutting operation.

The amplitude of the vibration depends on the circumference of the hair. The initial amplitude value can be approximately 100 to 200 μm (claim 9).

If both cutting edges vibrate simultaneously (claim 10) with phase-offset from one another, then half the amplitude suffices.

A system with adjustable amplitude and frequency for different material to be cut is thus possible, The piezoelectric travel transducer can be operates at an ultrasonic frequency (claim 8). It is integrated into at least one cutting edge. In a manner analogous to an ultrasonic cleaning sonotrode or a welding sonotrode, the longitudinal wave is transmitted along the cutting edge. The vibration generator, which in the final analysis is mechanical, may be disposed on the side of the cutting edge or strut of the scissors. If on the side of the strut, corresponding mechanical play at the bearing point would have to be considered. This applies equally to other vibrators on the strut (claim 5).

The system is triggered electrically by an ultrasonic generator, which is coupled via electrical connecting cords to the electromechanical vibrator.

Good cutting results are also attained if, as the vibrator, an eccentric washer that surrounds the nail of the joint is provided; if the eccentric washer is inserted into a round recess in the shank and is rotatably joined to the nail; and if a miniature motor is provided for rotating the eccentric washer about the nail (claim 3). To that end, a standard connecting nail is replaced with an electromechanically driven eccentric unit. The axial component of the eccentric motion leads to the desired cutting motion. As the drive for the eccentric unit, a miniature motor is sufficient and has the advantage of not making the scissors harder to manipulate.

The vibrator can also be embodied such that the shank at least in some regions comprises a magnetostrictive material, and a rigid, stationary exciter coil is wrapped around this material (claim 4). The cutting edges of the scissors are mounted here on a base body of magnetostrictive material. By applying an electromagnetic field to the magnetostrictive material, a change in length of the material and finally an oscillation of the cutting edges relative to one another are brought about. The exciter coils may be disposed in the strut region of the scissors. The exciter coil is connected to a generator via an electric connecting cord.

Nickel or a nickel alloy is suitable as the material (claim 6). First, nickel has the required magnetostrictive properties, and second, nickel steel is very highly suitable for manufacturing scissors. To prevent contact allergies, the material may have a plastic coating (claim 7).

The invention will be described in further detail below in conjunction with drawings that show exemplary embodiments. Shown are:

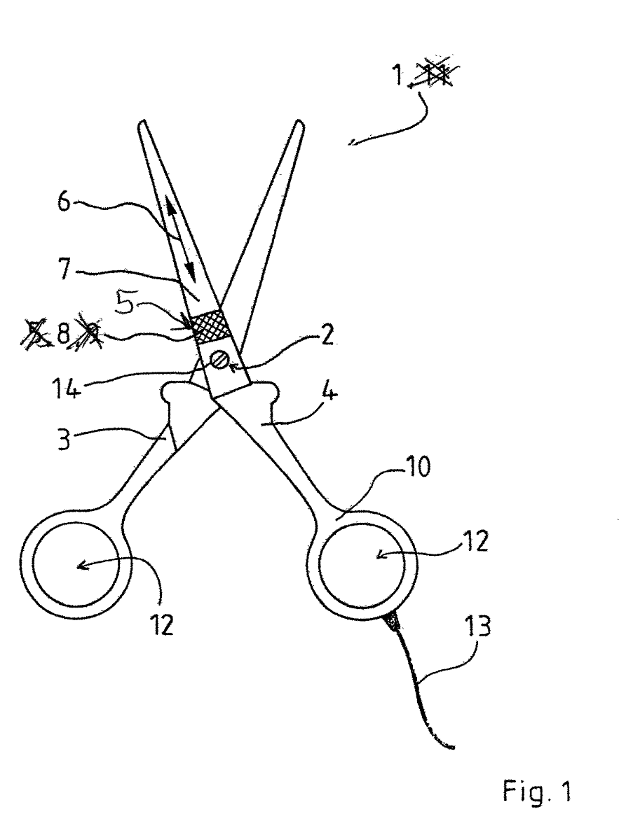

FIG. 1, in a side view, a pair of scissors whose shanks are pivotably connected to one another via a nail, and whose ends of the shanks toward the handles each have an eye; as the vibrator, a piezoelectric travel transducer is provided between one blade and the end of the shank;

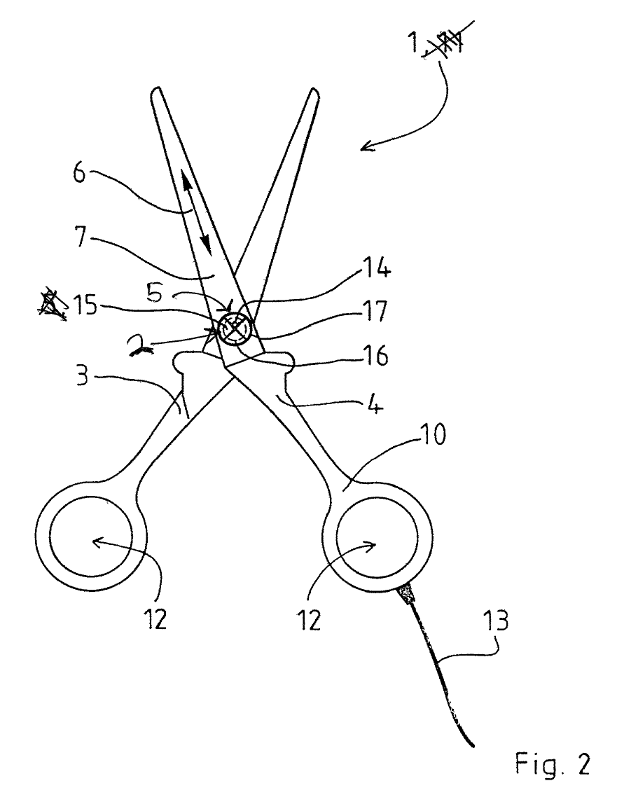

FIG. 2, in a side view, a pair of scissors analogous to FIG. 1, but with a vibrator which has an eccentric washer surrounding the nail and a miniature motor for turning the eccentric washer; and

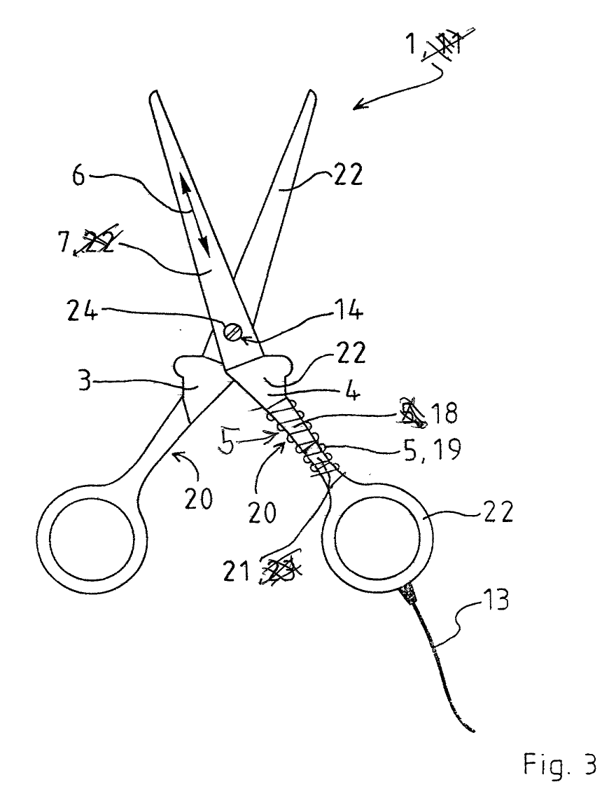

FIG. 3, in a side view, a pair of scissors analogous to FIG. 1, but with a vibrator which has a magnetostrictive material on a strut and a rigid, stationary exciter coil surrounding the material.

In a pair of scissors 1 with two shanks 3, 4 joined together via a joint 2, one shank 4 can be set into rotation (FIG. 1) parallel to the longitudinal direction 6 of the blade 7 of this shank 4 by means of an electrically powered vibrator 5. The vibrator 5 includes a piezoelectric travel transducer 8, which is located between the blade 7 and the joint 2. The piezoelectric travel transducer 8 is a connection 9 which joins the blade 7 and the end 10 of the shank 4 toward the handle to one another. The pair of scissors 1 is embodied as hairdressing shears 11, with eyes 12. An electric cord 13 supplies an ultrasonic frequency to the piezoelectric travel transducer 8. During a cutting operation, the vibration of the blade 7, whose amplitude is 150 μm, is utilized to cut hair better.

In the scissors 1 of FIG. 2, an eccentric washer 15 surrounding the nail 14 of the joint 2 is provided as the vibrator 5; it is inserted into a round recess 16 of the shank 4 and is rotatably connected to the nail 14. The eccentric washer 15 rotates about the nail 14. This rotary motion is attained by means of a miniature motor 17. The entire shank 4 executes the vibration.

In the exemplary embodiment of FIG. 3, a magnetostrictive material 18, around which a rigid, stationary exciter coil 19 is wrapped, is provided as the vibrator 5. The vibrator 5 is provided on the strut 20 of the shank 4. Only inside the exciter coil 19, within one strut region 21, has a magnetostrictive material 18 been used. Otherwise, the pair of scissors 1 has been made of conventional scissors steel 22. The material 18 is a nickel alloy 23.

At the nail 14, the shank 4 has a play 24 in the longitudinal direction 6 of the shank 4. The play 24 has a length of 150 μm in the longitudinal direction 6, corresponding to the amplitude of the vibration of the blade 7.

1. Scissors having two shanks connected to one another via a joint, characterized in that at least one shank (4) can be made to vibrate parallel to the longitudinal direction (6) of the blade (7) of this shank (4) by means of an electrically powered vibrator (5).

2. The scissors of claim 1, characterized in that the vibrator (5) includes a piezoelectric travel transducer (8), which is located between the blade (7) and an end (10) of the shank toward the handle, and which is a connection (9) between the blade (7) and the end (10) of the shank.

3. The scissors of claim 1, characterized in that as the vibrator (5), an eccentric washer (15) that surrounds the nail (14) of the joint (2) is provided; that the eccentric washer (15) is inserted into a round recess (16) in the shank (4) and is rotatably joined to the nail (14); and that a miniature motor (17) is provided for rotating the eccentric washer (15) about the nail (14).

4. The scissors of claim 1, characterized in that the shank (4), as the vibrator (5), at least in some regions comprises a magnetostrictive material (18), and that a rigid, stationary exciter coil (19) is wrapped around this material (18).

5. The scissors of claim 1, characterized in that the vibrator (5) is provided on the strut (20) of the shank (4), and that at the nail (14), the shank (4) has a play (23) in the longitudinal direction (6) of the shank (4).

6. The scissors of claim 4 or claim 5, characterized in that nickel or a nickel alloy (22) is provided as the material (18).

7. The scissors of claim 6, characterized in that the material has a plastic coating.

8. The scissors of claim 2, characterized in that the vibrator (5) is operated at an ultrasonic frequency.

9. The scissors of at least one of claims 1-8, characterized in that 100 to 200 μm are provided as the amplitude of the vibrator (5).

10. The scissors of at least one of claims 1-9, characterized in that a vibrator is provided on each of the two shanks.
